(19) United States
(12) Patent Application Publication
(10) Pub. No.: US 2008/0312020 A1
(43) Pub. Date: Dec. 18, 2008

(54) Plate-link chain

(75) Inventors: Anton Simonov, Buhl (DE); Michael Pichura, Buhl (DE); Marcus Junig, Buhl (DE); Olga Ispolatova, Buhl (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 12/156,127

(22) Filed: May 29, 2008

Related U.S. Application Data
(60) Provisional application No. 60/932,120, filed on May 29, 2007.

(51) Int. Cl. F16G 13/04

(52) U.S. Cl. 474/215

(57) ABSTRACT

A toothed plate-link chain that is employable in a vehicle drive train or other drive systems, in which rocker joints formed of link plates and rocker members are designed so that in spite of a requisite free play in the joint, protection against twisting of the rocked members is improved while at the same time noise is reduced. Additionally, no particular orientation of the rocker members relative to link plate openings is needed when assembling the rocker joint. The contours of each rocker member are formed mirror-symmetrically both to the X-axis and to the Y-axis.

### BACKGROUND OF THE INVENTION

1. Field of the Invention

The present invention relates to a toothed plate-link chain that can be incorporated in a motor vehicle drive system or another drive system.

2. Description of the Related Art

Toothed plate-link chains for transmitting power and that are composed of a plurality of interconnected links are known from the existing art. The links are hingedly connected to each other by connection joints, with the individual links including rocker members that are operatively connected to the link plates of the toothed chain. Because it is a toothed chain, the link plates have teeth on at least one side. To enable a connection between the rocker members and the individual link plates, each link plate has openings adjacent its ends to receive pairs of rocker members, so that the latter can be used to form a hinge with the link plates that located adjacent or behind and in front of it. Accordingly, the link plates are situated so that a plurality of them lying one after another longitudinally are coupled together through connection joints, so that individual plate sets are provided that produce a plate-link chain when the plate sets are linked together that can transmit large forces when the chain is under tension. To achieve a closed chain, the individual chain links must preferably be movable relative to each other in a plane. For that purpose, both the contact surfaces of the rocker members and the contact surfaces of the plate openings are formed as rolling surfaces. In that way the transmission of force can be achieved by means of the closed plate-link chain under tension.

A toothed plate-link chain can be employed in a transfer case of an all-wheel-drive motor vehicle, for example. However, it can also serve quite generally to bridge between spaced axles of a differential, or it can also be used as a means of transmitting power in an ancillary or auxiliary unit.

In all of those cases, the toothed chain is used to transmit a force from a driving sprocket wheel to a driven sprocket wheel. In so doing it undergoes a change of direction because of the sprocket wheel wheels, and hence it is redirected by them.

As mentioned earlier, the use of rocker members in the link plates results in rocker joints. The cross sections of the rocker members in that case are symmetrically formed in one plane and asymmetrically in the other plane. To transmit power, the rocker members are in contact with each other on their rolling surfaces, and they roll on the latter accordingly. The rolling surfaces are based on one or more radii.

If a tensile force is transmitted using the known plate-link chain, the rolling surface geometry of the rocker members can result in an unfavorable distribution of force in the region of the contact surfaces of the rocker members with the contact surfaces of the link plates. That unfavorable force distribution increases the danger of the rocker members twisting in the openings of the link plates, thus resulting in tension peaks that promote premature failure of the plate-link chain. Furthermore, when placing the rocker members in the openings of the link plates it is important to take care that they are inserted into the plate openings in the properly oriented position, otherwise the rolling surfaces provided for transmitting power between the rocker members cannot roll against each other as intended. That, in turn, results in the rocker members jamming in the plate opening, which results in an interruption of the transmission of force and ultimately to wear or failure of the plate-link chain.

To ensure a defined positional orientation of the rocker members in the openings of the link plates, unpublished German patent application DE 10 2005 061 081.1 describes a plate-link chain whose link plates have a region curved in an inward direction. In that arrangement an erroneous orientation of the rocker members in the link plates results in an overlap of the outside contour of the rocker members with the inside contour of the plate opening, so that the rocker member can no longer be inserted into the opening of the link plate. That prevents erroneous installation of the rocker members in the openings of the link plates.

Furthermore, U.S. Pat. No. 6,387,003 B2 discloses a plate-link chain constructed as a toothed chain whose connecting rocker members exhibit a particular cross-sectional shape relative to the shape and size of the plate openings. That shape is designed so that on the one hand the required mobility in the vicinity of the joint is ensured, but on the other hand the free play in the joint is kept small. That is intended to prevent the rocker members from twisting in the plate openings and the plate openings from being deflected.

The same problem is solved in Japanese published application JP 05-312238 A by adjusting the shape of the contact surfaces of one of the rocker members situated in pairs in a plate opening to the shape of the active contact surfaces of the plate opening, with only the contact surface of the other rocker member having free play with the surrounding contact surface of the plate opening. However, automatic assembly is very complicated and expensive with that solution.

An object of the present invention is therefore to provide a toothed plate-link chain in such a way that in spite of the need for free play in the rocker joints the resistance to twisting is improved, while at the same time noise is reduced and no additional orientation of the rocker members is needed when assembling a rocker joint.

### SUMMARY OF THE INVENTION

In accordance with one aspect of the present invention, the links of a plate-link chain made of link plates are connected with each other through rocker members that have a certain contour. A link plate is provided with two openings, each to receive one associated rocker member, with the contour of the plate opening being matched to the contour of two progressing rocker members. To form each rocker joint, the rocker members of the adjacent link plates are additionally received in one of the plate openings of the link plate. The plate openings have contact surfaces in the region of contact with the rocker members. The contour of the rocker members is formed by short and long contact surfaces, with a short contact surface being joined in each case with a long contact surface in an arc shape. The contour of the rocker member is designed so that it is mirror-symmetrical in form in relation to both the X-axis and the Y-axis.

That simple, mirror-symmetrical design of the cross section of a rocker member has the advantage that simple manufacturing is possible by rolling or by means of drawing dies, which results in greater bending strength because the stress concentrations brought about by the manufacturing process are small. Furthermore, no orientation aids are needed to properly install the rocker members in the plate openings. Accordingly, the check of geometry is simplified by the possibility of utilizing simple devices with defined contact surfaces.

In an advantageous form of the invention, the short contact surfaces can be provided with a bulge or a depression, whose contour is however mirror-symmetrical to the X- and Y-axes. That measure subdivides each of the short contact surfaces into two equal, shorter contact surfaces, which reduces the friction on the short contact surfaces and thereby increases the service life of a rocker member.

To ensure the functional capability of a plate-link chain over the entire bending angle range, it is especially advantageous that the contact surfaces in the plate openings be designed so that the X-axes of the installed rocker members assume an angle relative to the link plate that corresponds to ¼ of the maximum bending angle of the chain. In that way the friction between the contact surfaces of the two components is reduced.

Furthermore, it is advantageous that the long contact surfaces of the rocker members, which serve to transmit power, have a rolling zone. Accordingly, that rolling zone is present on both long surfaces, so that the two rocker members received in a plate opening can roll against each other in their rolling zones. The rolling zone, in turn, is designed so that it is mirror-symmetrical to the X-axis, and is made up of three regions that are based on different radii. Those different radii are essentially a larger and a smaller radius, where the region having the smaller radius is enclosed on both sides by the regions having the larger radius.

The transitions from one region to the other can be of discontinuous form, or they can extend gradually through variable radii.

The rolling process of the two rocker members thus takes places in the region of both rolling zones, which are constructed as mirror images of each other.

However, it is important for the distribution of forces on the rocker member, and thus for prolonging its service life, that both the region with the smaller radius and the region with the smaller, variable radii be located in the middle of the rolling zone.

It is also advantageous that the contact surface in the plate opening of the link plate be subdivided into two contact surfaces of equal size by a recess that is mirror-symmetrical to the X-axis, whereby a definable positioning of the rocker member in the plate opening is achieved.

In another advantageous design of the invention, one of the angles that is formed between the normal line standing perpendicular to the short contact surface and the line of application of the force acting on that contact surface is smaller than 5.7°. The lines of application of the rocker joint contact forces remain in effect between the contact surfaces of the two components. In addition, a self-arresting effect develops between the rocker member and the link plate, which prevents the rocker member from tipping.

Again, for the positioning of the rocker member and for the distribution of forces on the latter it is advantageous if the recess is mirror-symmetrical to the X-axis.

To prolong the service life of the plate-link chain and to enable automated assembly, it is advantageous that there be free play present between the upper and lower contact surfaces of a plate opening and the short contact surfaces of a rocker member.

### BRIEF DESCRIPTION OF THE DRAWINGS

The structure, operation, and advantages of the present invention will become further apparent upon consideration of the following description, taken in conjunction with the accompanying drawings in which:

FIG. 1 is a side view of a toothed chain encircling a driving sprocket wheel and a driven sprocket wheel;

FIGS. 2a, 2b show two different rocker member cross-sectional shapes;

FIG. 3 is a side view of a plate-link chain with an embodiment of a rocker member in accordance with the present invention in each plate opening;

FIGS. 4a, 4b show a rocker joint from the straightened zone of the toothed chain, with differently designed rolling zones;

FIGS. 5a, 5b show a rocker joint with differently designed rolling zones, from the curved zone of the toothed chain;

FIG. 6 shows a rocker joint of the toothed chain that is in the swing-back process; and

FIGS. 7a, 7b show a rocker joint with anti-twisting protection.

### DESCRIPTION OF THE PREFERRED EMBODIMENTS

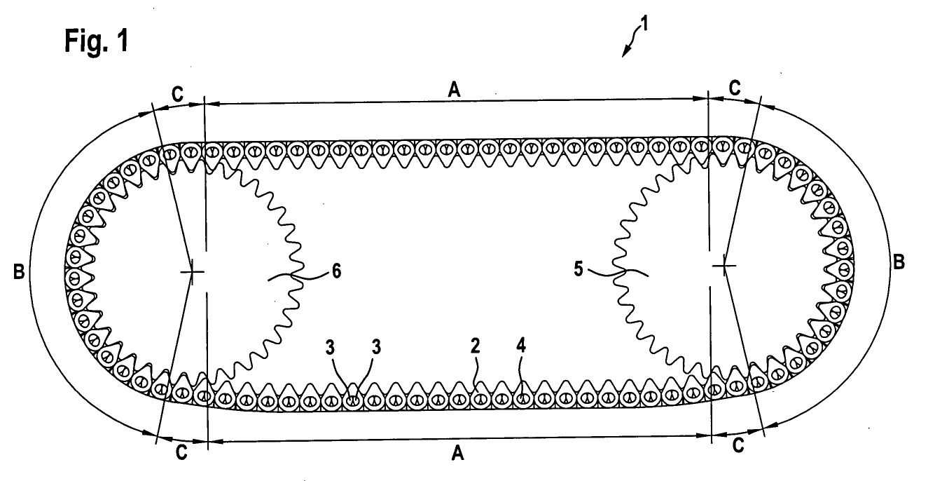

FIG. 1 shows a toothed chain 1 that endlessly encircles a driving sprocket wheel 5 and a driven sprocket wheel 6. The spacing between the sprocket wheels 5, 6 results in the load conditions A, B, and C for the toothed chain 1, where load condition A represents the straightened zone of toothed chain 1, and load condition B represents the curved zone of toothed chain 1 that encircles a sprocket wheel 5, 6. Between those load conditions A and B lies the transition zone C.

Toothed chain 1 is composed of an appropriate number of chain links that are situated behind and beside one another over a certain width. The chain links consist of link plates 2. To form the toothed chain 1, link plates 2 are provided on one edge with at least one tooth that extends transversely to the running direction of the chain. In the example shown the link plates have two teeth. In the running direction of the chain the link plates 2 have a plate opening 2a at each end (see FIG. 3). A plurality of link plates 2 are situated one behind the other in a plurality of planes for a plate set.

The link plates 2 are connected with each other by rocker members 3 that are inserted into the plate openings 2a as shown in FIG. 3, with the rocker member 3 that is located in a plate opening 2a of a first link plate 2, together with a rocker member 3 of a second link plate 2 lying behind it, being situated in the plate opening 2a of that first link plate 2. In that way, the plate openings 2a situated one behind the other, in combination with the rocker members 3, serve in each case to form a rocker joint 4. Thus, in each case a rocker member 3 of a first link plate 2 is associated with the operatively connected rocker member 3 of a second link plate 2 (located behind or ahead of it).

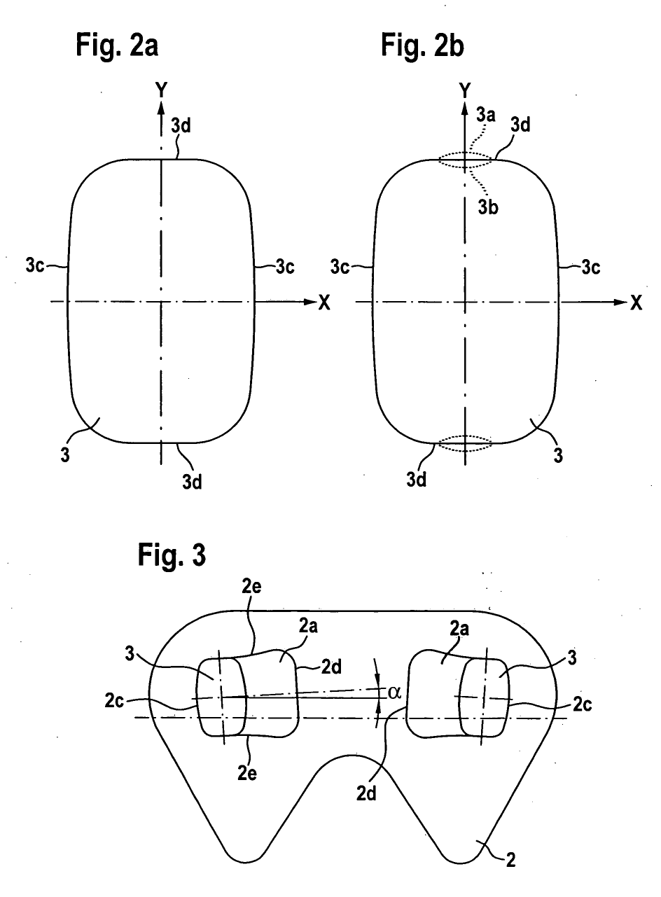

FIGS. 2a and 2b each show an end view of a rocker member 3 in accordance with the invention. It is evident that the shape of rocker members 3 in both figures is mirror-symmetrical to both the X-axis and the Y-axis. In FIG. 2a the rocker member 3 has a generally rectangular shape, with the corners all being rounded off. Both the surfaces in the Y direction that serve as rolling surfaces and the lateral surfaces in the X direction that serve as contact surfaces 3d do not form straight lines, but rather describe a curve. For the rolling surfaces in particular, the basic form is provided by a plurality of radii.

FIG. 2b shows various possible variations of the rocker member 3 showed in FIG. 2a, which differ in the shape of the short contact surfaces 3d. Thus the short contact surfaces 3d of the rocker member 3 that extend “straight” in FIG. 2a, can be provided with bulges 3a or depressions 3b, for example. It is important here, however, that those contour changes be mirror-symmetrical to the Y-axis. That mirror-symmetrical contour of rocker member 3 results in there being no need for any orientation marking during manufacturing, and thus also no need for any orientation aid when installing them in the plate opening 2a, which makes it possible to lower the costs of manufacturing and assembly. Furthermore, that makes it possible to check the geometry using simpler devices with defined contact surfaces. Furthermore, in the variant without bulges 3a it results in smaller concentrations of stresses in the rocker member 3, which increases the bending strength.

FIG. 3 shows a link plate 2 with the rocker members 3 associated with it inserted into the plate openings 2a, which as part of a toothed chain 1 is appropriately provided with teeth. It can be seen from FIG. 3 that the plate openings 2a, whose size is adapted to receive two rocker members 3 lying against each other, are formed in the link plate 2 at an installation angle α relative to a longitudinal plane extending through link plate 2. Because rocker member 3 rests with its rolling surface 3c against the contact surface 2c of the plate opening 2a, its position in the plate opening 2a is prescribed at the same time. In order to ensure the function of toothed chain 1, the installation angle α should preferably be chosen so that it is greater than ¼ of the maximum bending angle of the chain. The maximum bending angle of the chain is found by dividing 3600 by the minimum number of sprocket wheel teeth that can still be covered by the toothed chain 1.

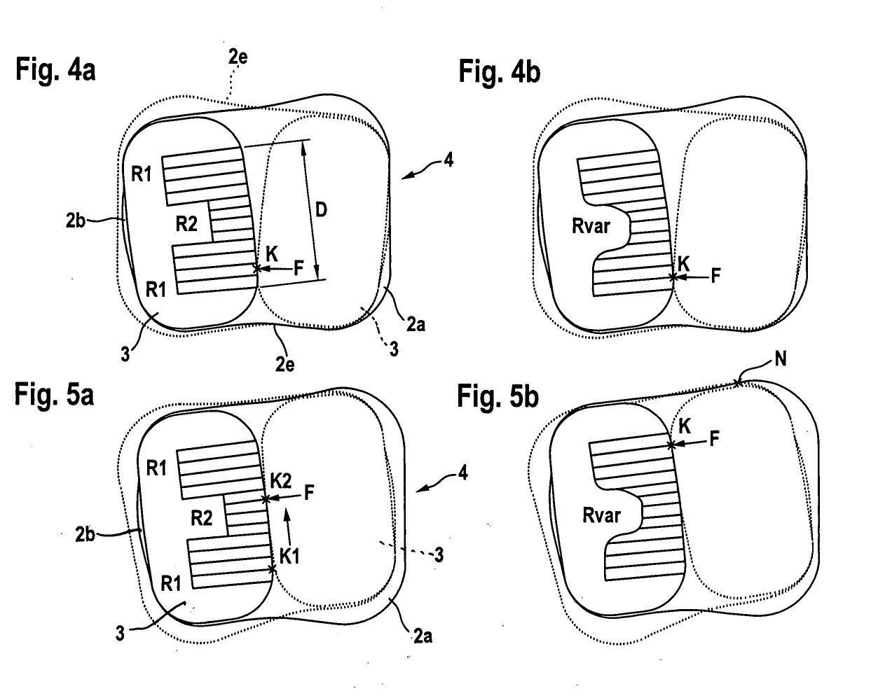

FIGS. 4a and 4b each show a rocker joint 4 in load condition A, in which the tensile force F to be transmitted acts on rocker joint 4 at the force application point K. As mentioned earlier, a rocker joint 4 is always formed from two plate openings 2a, one positioned behind the other, in combination with one pair of rocker members 3. In that figure, the upper link plate 2 (where “upper” is in the context of the plane of the drawing) or its plate opening 2a with the associated rocker member 3 is represented by solid lines. In contrast, the outlines of the adjacent link plate 2 or adjacent plate opening 2a and its corresponding rocker member 3, which is operatively connected with the rocker member 3 of the upper link plate 2 through the rolling surface D, are represented only by dotted lines. Since the two rolling surfaces D of the rocker members 3 are situated mirroring each other, the design of the rolling surface D will be described in greater detail based only on the example of the upper rocker member 3.

At first glance, the two FIGS. 4a and 4b appear to be substantially the same. They differ only in the shape of the rolling surface D achievable on the rocker member 3, which is made up of individual zones, with the radii underlying the respective zones reflected on the X-axis. In FIG. 4a there are essentially three zones with different radii that form the basis for the rolling surface or rolling zone D. The radii underlying the individual zones include two radii R1 and R2, with radius R1 being greater than radius R2. The zone with the smaller radius R2 is bounded on both sides by a zone with the larger radius R1. The zones are situated so that a mirror-symmetrical shape of the rolling surface D results relative to the X-axis of the rocker member 3. It can also be seen from FIG. 4a that a discontinuity or step exists in each case between the larger radius R1 and the smaller radius R2.

In FIG. 4b, in contrast, that discontinuity is softened by a gradual transition from one radius to the other by means of variable radii Rvar. Of course, instead of that series of three zones with the radii R1, R2, R1 it is also possible to choose a contour that corresponds approximately to the adjacent series of zones with corresponding radii. As a result of that design of the contour of the rolling zone D on the rocker member 3, only a low contact pressure occurs in load condition A, since here the contact point K is in the zone with the larger radius R1. That, in turn, results in prolonging the fatigue strength of the toothed chain, since each rocker joint is in load condition A longest. Furthermore, that contour of the rolling zone D enables the noise of the toothed chain 1 during operation to be reduced significantly.

FIGS. 5a and 5b, analogous to FIGS. 4a and 4b, each show a rocker joint 4 in load condition B, in which the two rocker members 3 in plate opening 2b roll against each other on their rolling surfaces 3c, in particular in the rolling zone D, depending upon the angle of wrap of the toothed chain 1 around one of the sprocket wheels 5, 6. In that condition of the toothed chain 1 the force application point K of the force F is located at the force application point K2. Thus, starting from load condition A the force application point K has shifted from a starting point K1 to an end point K2, which causes the rocker joints 4 to be curved in that load condition B. In those figures as well, the outline of only the plate opening 2a of an upper link plate 2 with the associated rocker member 3 is represented by a solid line. In that load condition B, by using the smaller radius or radii R2 in the middle of the rolling zone D the shift of the force application point K from K1 to K2 is reduced, which leads to improved force distribution in terms of supporting the link plate 2. If the rocker joint 4 is not completely curved clear to the stop, as shown in FIG. 5a, a greater contact pressure develops than in load condition A, since radius R2 is smaller than radius R1. That higher contact pressure between the rocker members 3 in rocker joint 4 is less damaging to toothed chain 1, however, since the proportion of time that rocker joint 4 undergoes high forces in load condition B is relatively small. The high forces between the rocker members 3 therefore act only briefly in the transition zones C of the chain fragment under tension in the encirclement. If the rocker joint 4 is curved further, as can be seen in FIG. 5b, the contact pressure again reaches the level of the contact pressure in load condition A. As shown in FIG. 5b, in load condition B a stop occurs at contact point N of that link plate 2 on the inner contour of the adjacent link plate 2.

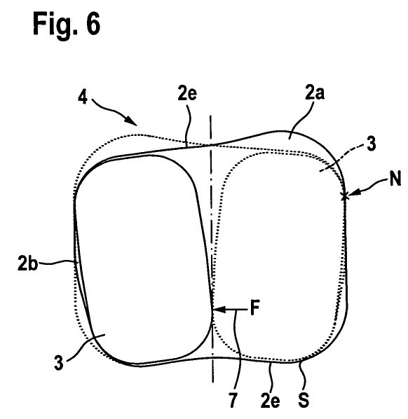

FIG. 6 shows a rocker joint 4 that is in a swing-back process. Here the contact zone in load condition A, i.e., in the straightened state of the toothed chain 1, is located between the dotted-line rocker member 3 in the corresponding plate opening 2a of the dotted-line link plate 2 and the inner contour of for example the upper adjacent link plate 2, above the contact line 7 between the rocker members 3. Thus, at a pivoting motion of the link plate 2, when toothed chain 1 swings back, a contact that transmits the force F is created between the contact surface of the “free” rocker member 3 and, depending upon the direction of circulation of the toothed chain 1, an upper or a lower contact surface 2e of the plate opening 2a of the link plate 2. Since contact point N lies above the contact line 7 of application of the force F in the straight strand, it therefore lies outside of the tension-critical zone of the link plate 2. That mitigates the wear point on the inner contour of the plate opening 2a of the adjacent link plate 2. In that process, a free play S develops between the “free” rocker member 3 and the plate opening 2a of the adjacent link plate 2, between their two lower contact surfaces 3d and 2e.

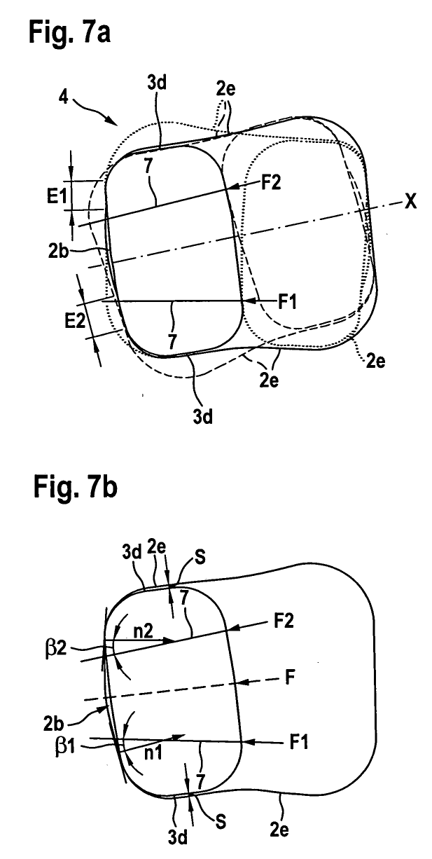

FIGS. 7a and 7b show a rocker member 3 in accordance with the present invention with anti-twisting protection. As already mentioned in connection with FIGS. 2a and 2b, the two long surfaces of the rocker member 3 that serve as contact surfaces 3c are mirror-symmetrical relative to the X-axis. Furthermore, it can be seen from FIGS. 7a and 7b that an interruption in the form of a widening at 2b of the contact surface 2c of the plate opening 2a, in the form of a recess, is needed so that two spaced contact surfaces E1 and E2 result, in order to achieve a defined position of a rocker member within plate opening 2a. However, as shown in FIG. 7a, in the operating state the contact lines or application lines 7 of the contact forces F1, F2 on the rocker joint 4 must remain between those two contact surfaces E1, E2, in order to prevent tilting of the rocker member 3 in the plate opening 2a.

To provide further explanation, in FIG. 7b the tangents to the contact surfaces E1 and E2 are also shown, with their perpendicular normals n1 and n2. A force F acting on the rocker joint 4 is divided into force components F1 and F2 by the two contact surfaces E1 and E2. It becomes evident from FIG. 7b that at least one of the angles β1 or β2 formed between the application lines 7 of the contact surfaces F1, F2 of the rocker joint 4 and at least one normal n1, n2 must be smaller than 5.7° in order to fulfill the self-locking or positioning function. Thus, a possible twisting of the rocker member 3 is prevented with all of the flexing angles, in particular in load condition B. The size of the angle β to achieve the self-locking function is calculated from the self-locking condition, in accordance with which the angle β should be smaller than the arc tangent of the coefficient of friction of 0.1.

However, because of the symmetry of the rocker member 3 relative to the Y-axis, contact surfaces E1 and E2 can also assume the function of rolling surfaces for the rolling process with the operatively connected rocker member 3. The free play S between the upper and lower contact surfaces 3d of the rocker member 3 and the contact surfaces 2e of the plate opening 2a should be designed so that installation of the rocker member 3 in the plate opening can be automated.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A toothed plate-link chain comprising: a plurality of link plates that are interconnected with adjacent link plates by rocker members having an outer contour, wherein each of the link plates has two plate openings to receive associated rocker members to form a rocker joint; wherein the plate openings have contact surfaces that are matched to the outer contour of the rocker members, and wherein the outer contour of the rocker members is formed by oppositely-facing first contact surfaces and oppositely-facing second contact surfaces, wherein the second contact surfaces are longer than the first contact surfaces and in each case a first contact surface is joined to a second contact surface by an arc; wherein the outer contour of the rocker members in cross section is mirror-symmetrical relative to both an X-axis and a Y-axis.

2. A plate-link chain in accordance with claim 1, wherein the first contact surfaces of the rocker members include an outwardly-extending bulge.

3. A plate-link chain in accordance with claim 1, wherein the first contact surfaces of the rocker members include an inwardly-extending depression.

4. A plate-link chain in accordance with claim 2, wherein the bulge has a contour that is mirror-symmetrical relative to the X and Y axes.

5. A plate-link chain in accordance with claim 1, wherein the plate openings have a longitudinal axis in a running direction of the chain that is positioned at an angle to a longitudinal direction of the link plate and that corresponds to ¼ of a maximum chain bending angle.

6. A plate-link chain in accordance with claim 1, wherein the second contact surfaces of the rocker members have a rolling zone formed mirror-symmetrically to the X-axis and that includes three zones that are based upon two different radii, wherein a radius at regions outward of the X-axis is greater than a radius adjacent the X-axis, and wherein a zone with a smaller radius is adjoined on both sides by a zone with a larger radius.

7. A plate-link chain in accordance with claim 6, wherein a transition between the zone with the larger radius to the zone with the smaller radius is stepped.

8. A plate-link chain in accordance with claim 6, wherein a transition between the zone with the larger radius to the zone with the smaller radius is a gradual transition defined by varying radii.

9. A plate-link chain in accordance with claim 7, wherein the zone with the smaller radius is located in the middle of the rolling zone.

10. A plate-link chain in accordance with claim 1, wherein the contact surfaces in the plate openings are subdivided into two contact surfaces of equal size by a recess that is mirror-symmetrical to the X-axis.

11. A plate-link chain in accordance with claim 10, wherein an angle between normals to the contact surfaces on each side of the recess and an application line of a force acting on the link plate contact surface is smaller than 5.7°.

12. A plate-link chain in accordance with claim 10, wherein contact surfaces of the plate openings contacted by the second contact surfaces of the rocker members include a recess that is mirror-symmetrical to the X-axis.

13. A plate-link chain in accordance with claim 1, including a free play region between the contact surfaces of the plate opening and the contact surfaces of the rocker member.

14. A plate-link chain in accordance with claim 3, wherein the depression has a contour that is mirror-symmetrical relative to the X and Y axes.

15. A plate-link chain in accordance with claim 8, wherein the zone with the smaller variable radii is located in the middle of the rolling zone.
